(19) United States
(12) Patent Application Publication
(10) Pub. No.: US 2024/0353165 A1
(43) Pub. Date: Oct. 24, 2024

(54) REFRIGERATOR

(71) Applicant: LG ELECTRONICS INC., Seoul (KR)

(72) Inventor: Sunghun LEE, Seoul (KR)

(73) Assignee: LG ELECTRONICS INC., Seoul (KR)

(21) Appl. No.: 18/439,955

(22) Filed: Feb. 13, 2024

(30) Foreign Application Priority Data
Apr. 20, 2023 (KR) 10-2023-0052315
Sep. 8, 2023 (KR) 10-2023-0119750

(51) Int. Cl. F25D 23/02; E05F 3/18

(52) U.S. Cl. CPC F25D 23/028; E05F 3/06; E05Y 2900/31; F25D 2323/024

(57) ABSTRACT

A refrigerator includes a cabinet having a storage space, a door configured to open and close the cabinet, a hinge bracket configured to connect the door to the cabinet and support the door to be rotatable, an auto-closing device configured to act with a hinge bracket during the closing process of the door so as to provide closing force to the door, and a damping mechanism configured to provide damping force to the door while the auto-closing device provides the closing force to the door.

### CROSS-REFERENCE TO RELATED APPLICATIONS

The present application claims priority under 35 U.S.C. 119 to Korean Patent Application No. 10-2023-0052315, filed in the Republic of Korea on Apr. 20, 2023, and Korean Patent Application No. 10-2023-0119750, filed in the Republic of Korea on Sep. 8, 2023, which are hereby incorporated by reference in their entireties.

### BACKGROUND

The present disclosure relates to a refrigerator.

In general, a refrigerator is a home appliance for storing foods in an internal storage space, which is shield by a door, at a low temperature by low temperature air. For this, the refrigerator is configured to accommodate the stored food in an optimum state by cooling the internal storage space using cold air generated through heat exchange with a refrigerant circulating in a refrigeration cycle.

In recent years, refrigerators tend to increase more and more in size and provide multi-functions due to the trends of change of dietary life and high quality, and thus, refrigerators having various structures in consideration of user convenience are brought to the market.

When a device is provided to provide a space for door storage of a refrigerator or to provide additional functions such as an ice maker or dispenser, a weight of the door increases. Even when heavy materials such as glass and metal are used to enhance an outer appearance of the refrigerator door, the weight of the door increases.

When the weight of the refrigerator door increases, there is a limitation that it takes a lot of effort to open and close the refrigerator door, and limitations such as noise or items falling due to an impact at the moment the door is closed may occur.

To solve these limitations, a refrigerator including a device that provides door closing force to a door rotation axis or a position that is adjacent to the door rotation axis is disclosed in Korea Patent Publication No. 10-2006-0075659 and Korea Patent Publication No. 10-2022-0132619.

However, in these technologies according to the related art, there is a limitation in that the closing force applied to the door is added, and thus, more force is required when opening the door, and there is a limitation in that the door is opened due to repulsive force at the moment the door is closed.

### SUMMARY

Embodiments provide a refrigerator in which a door is automatically closed during a door closing process, and an impact is reduced by a damping mechanism when the door is closed.

Embodiments also provide a refrigerator in which an impact is reduced by a damping mechanism during a door closing process, while preventing resistance of the damping mechanism from acting when the door is opened.

Embodiments also provide a refrigerator in which a door is automatically closed even if a door thickness is small, and an impact is reduced during a door closing process.

In one embodiment, a refrigerator includes: a cabinet having a storage space; a door configured to open and close the cabinet; a hinge bracket configured to connect the door to the cabinet and support the door to be rotatable; an auto-closing device configured to act with a hinge bracket during the closing process of the door so as to provide closing force to the door; and a damping mechanism configured to provide damping force to the door while the auto-closing device provides the closing force to the door.

The auto-closing device may include: a lever configured to be rotatable at a position that is spaced apart from a rotation center of the door; and an elastic member connected to the lever.

The damping mechanism may include a damper that is in contact with the lever.

The damping mechanism may further include a fixing bracket configured so that the damper is installed on the door at one side of the auto-closing device.

The damper may include a movable member and a fixed member. The movable member may be connected to the lever or in contact with one surface of the lever.

A portion of the lever may be disposed between the damper and a rotation center of the lever.

The movable member may include a connection portion, and the lever may include a slot to which the connection portion is coupled.

The damper may be installed on the auto-closing device or installed on the door at a position that is adjacent to the auto-closing device.

The auto-closing device may include a case configured to accommodate the elastic member.

An outer body configured to accommodate the damper may be provided on the case. The outer body configured to accommodate the damper may be installed on the door at a position that is adjacent to the case.

The damper may include a movable member and a fixed member. The movable member may be in contact with the lever between the rotation center of the door and a rotation center of the lever.

The damper may include a movable member, a fixed member, and a spring configured to provide elastic force to the movable member.

When the lever moves in one direction while the door is closed, the movable member of the damper may move from a first position to a second position.

When the lever moves in the other direction while the door is additionally closed, the movable member of the damper may be configured to provide damping force to the door while moving from the second position to the first position.

The auto-closing device may include: a lever configured to be rotatable at a position that is spaced apart from a rotation center of the door; an elastic member connected to the lever; and a case configured to accommodate the elastic member.

The damping mechanism may be disposed inside the case.

The damping mechanism may include: a first member connected to the lever within the case; and a second member configured to be relatively movable with respect to the first member.

When the first member rotates, the second member may linearly move.

A rotation center of the first member may be the same as a rotation center of the lever.

The damping mechanism may further include an elastic member configured to elastically support the second member.

The first member may include a first space in which oil is accommodated. The second member may include a second space in which oil is accommodated. A buffer space in which oil may be accommodated is defined between the case and the second member.

The first member may include a first uneven portion. The second member may include a second uneven portion that is engaged with the first uneven portion according to a position of the first member.

When the lever moves in one direction while the door is closed, the second member of the damper may move from a first position to a second position.

When the lever moves in the other direction while the door is additionally closed, the second member of the damper may be configured to provide damping force to the door while moving from the second position to the first position.

At least a portion of the first uneven portion of the first member may be spaced apart from the second member at the second position. The first uneven portion may be in contact with and engaged with the second uneven portion at the first position.

The details of one or more embodiments are set forth in the accompanying drawings and the description below. Other features will be apparent from the description and drawings, and from the claims.

### BRIEF DESCRIPTION OF THE DRAWINGS

FIG. 1 is a front view of a refrigerator according to a first embodiment.

FIG. 2 is a view when a door of the refrigerator of FIG. 1 is viewed from the below.

FIG. 3 is an enlarged view of a portion A of FIG. 2.

FIG. 4 is a view illustrating a state in which an auto-closing device and a damping mechanism are connected to each other according to the first embodiment.

FIG. 5 is a view illustrating the damping mechanism and a cover member according to the first embodiment.

FIG. 6 is a bottom view of a hinge bracket according to the first embodiment.

FIG. 7 is a view illustrating a state in which a contact portion of a lever is in contact with a first part in a state in which a closing angle of a first door is a set angle according to the first embodiment.

FIG. 8 is a view illustrating a state in which the closing angle of the first door of FIG. 7 is reduced, and thus, the contact portion is disposed at a boundary between the first part and a second part.

FIG. 9 is a view illustrating a state in which the first door is closed according to the first embodiment.

FIG. 10 is a view illustrating a configuration in which an auto-closing device and a damping mechanism are installed in a first door according to a second embodiment.

FIG. 11 is a view illustrating a state in which a portion of the damping mechanism is separated from the auto-closing device.

FIG. 12 is a view illustrating a state in which a contact portion of a lever is in contact with a first part in a state in which a closing angle of the first door is a set angle according to the second embodiment.

FIG. 13 is a view illustrating a state in which the closing angle of the first door of FIG. 12 is reduced, and thus, the contact portion is disposed at a boundary between the first part and a second part.

FIG. 14 is a view illustrating a state in which the first door is closed according to the second embodiment.

FIG. 15 is a bottom view of a first door according to a third embodiment.

FIG. 16 is a cross-sectional view taken along line 16-16 of FIG. 15.

FIG. 17 is a view illustrating a state in which a first member rotates in FIG. 16.

FIG. 18 is a view illustrating a state in which a contact portion of a lever is in contact with a first part in a state in which a closing angle of the first door is a set angle according to the third embodiment.

FIG. 19 is a view illustrating a state in which the closing angle of the first door of FIG. 17 is reduced, and thus, the contact portion is disposed at a boundary between the first part and a second part.

FIG. 20 is a view illustrating a state in which the first door is closed according to the third embodiment.

FIG. 21 is a view illustrating an arrangement of an auto-closing device and a damping mechanism according to a fourth embodiment.

FIG. 22 is a view illustrating the damping mechanism and a cover member according to the fourth embodiment.

FIG. 23 is a view illustrating a state in which a contact portion of a lever is in contact with a first part in a state in which a closing angle of the first door is a set angle according to the fourth embodiment.

FIG. 24 is a view illustrating a state in which the closing angle of the first door of FIG. 23 is reduced, and thus, the contact portion is disposed at a boundary between the first part and a second part.

FIG. 25 is a view illustrating a state in which the first door is closed according to the fourth embodiment.

FIG. 26 is a view illustrating an auto-closing device and a damping mechanism according to a fifth embodiment.

FIG. 27 is a view illustrating a state in which a contact portion of a lever is in contact with a first part in a state in which a closing angle of a first door is a set angle according to the fifth embodiment.

FIG. 28 is a view illustrating a state in which the closing angle of the first door of FIG. 27 is reduced, and thus, the contact portion is disposed at a boundary between the first part and a second part.

FIG. 29 is a view illustrating a state in which the first door is closed according to the fifth embodiment.

### DETAILED DESCRIPTION OF THE EMBODIMENTS

Hereinafter, some embodiments of the present disclosure will be described in detail with reference to the accompanying drawings. It should be noted that when components in the drawings are designated by reference numerals, the same components have the same reference numerals as far as possible even though the components are illustrated in different drawings. Further, in description of embodiments of the present disclosure, when it is determined that detailed descriptions of well-known configurations or functions disturb understanding of the embodiments of the present disclosure, the detailed descriptions will be omitted.

Also, in the description of the embodiments of the present disclosure, the terms such as first, second, A, B, (a) and (b) may be used. Each of the terms is merely used to distinguish the corresponding component from other components, and does not delimit an essence, an order or a sequence of the corresponding component. It should be understood that when one component is “connected”, “coupled” or “joined” to another component, the former may be directly connected or jointed to the latter or may be “connected”, coupled” or “joined” to the latter with a third component interposed therebetween.

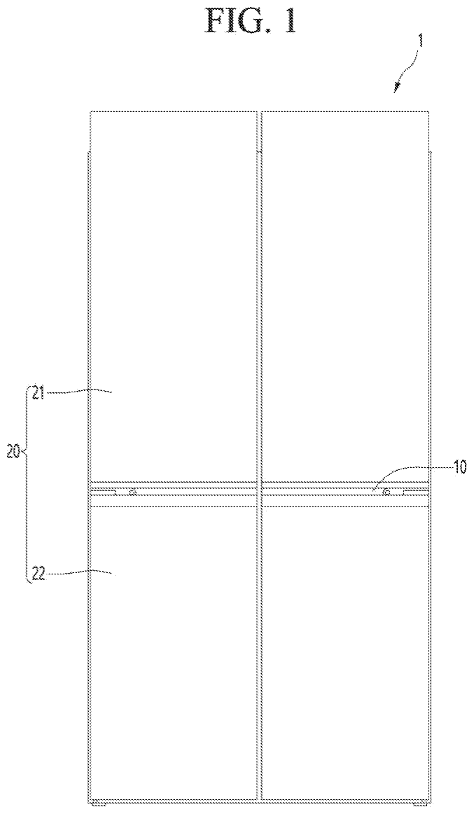

Before explaining the embodiments, various directions are defined. In an embodiment of the present disclosure, a direction facing a front surface of the door illustrated in FIG. 1 may be defined as a front direction, a direction facing a cabinet with respect to the front surface of the door will be defined as a rear direction, a direction facing a bottom surface on which the refrigerator is installed will be defined as a downward direction, and a direction that is away from the bottom surface will be defined as an upward direction. In addition, when indicating a previously undefined direction, the direction can be defined and explained based on each drawing.

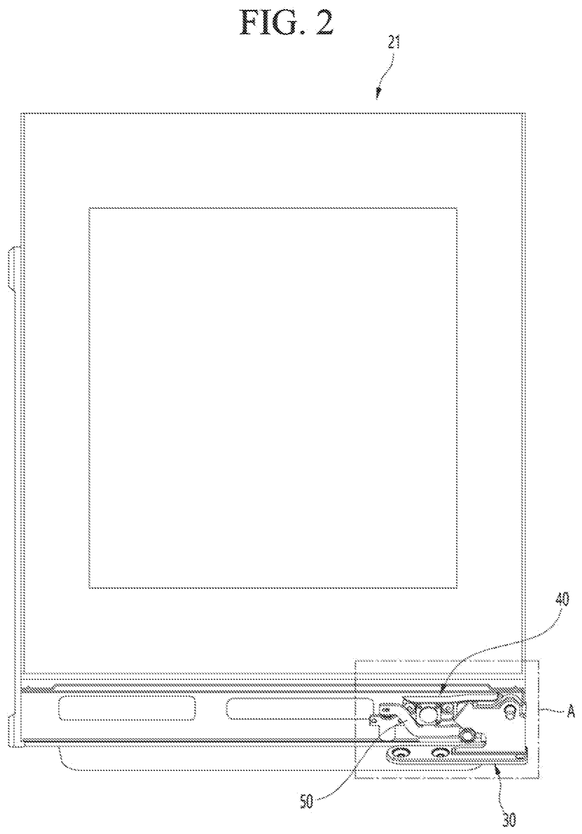

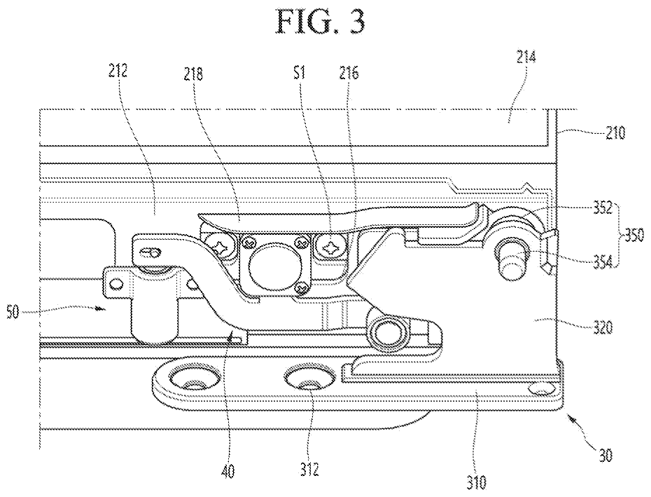

FIG. 1 is a front view of a refrigerator according to a first embodiment, and FIG. 2 is a view when a door of the refrigerator of FIG. 1 is viewed from the below. FIG. 3 is an enlarged view of a portion A of FIG. 2.

Referring to FIGS. 1 to 3, a refrigerator 1 according to an embodiment may be installed independently in a kitchen or installed in an indoor furniture cabinet or wall. When the refrigerator 1 is installed in the indoor furniture cabinet or wall, the refrigerator 1 may be installed alone or arranged side by side with the other refrigerator.

The refrigerator 1 may include a cabinet 10 having a storage space. The refrigerator 1 may further include a refrigerator door 20 that opens and closes the storage space.

Although not limited, the storage space may be divided into a first space, which is defined at an upper side, and a second space, which is defined at a lower side.

The refrigerator door 20 may include a first door 21 that opens and closes the first space and a second door 22 that opens and closes the second space.

The first space may be a refrigerating compartment, and the second space may be a freezing compartment or vice versa. Alternatively, the storage space may include a first space and a second space, which are divided into left and right sides. Alternatively, the storage space may be a single space, and a single refrigerator door may open and close the storage space.

At least one or more of the first door 21 and the second door 22 may be a rotation type door. Alternatively, the single refrigerator door 20 may be a rotation type door.

In this embodiment, the rotation type refrigerator door 20 may include an auto-closing device 40 that provides closing force to the refrigerator door 20 in a state in which the refrigerator door 20 is opened and then closed again at a certain angle.

In FIG. 2, an example in which the auto-closing device 40 is provided in the first door 21 of the first door 21 and the second door 22, which are arranged in a vertical direction will be described. It should be noted that the position of the auto-closing device 40 is not limited.

When the first door 21 and the second door 22 are arranged in the vertical direction, a hinge bracket 30 is provided between the first door 21 and the second door 22.

The hinge bracket 30 may provide a rotational center of the first door 21. Alternatively, the hinge bracket 30 may be a common bracket that provides a rotational center of each of the first door 21 and the second door 22. Alternatively, the hinge bracket may be disposed at an upper side of the first door 21, and the hinge bracket may also be disposed at a lower side of the second door 22.

The hinge bracket 30 may be fixed to a front surface of the cabinet 10.

The hinge bracket 30 may include a coupling portion 310 to be coupled to the cabinet 10. The hinge bracket 30 may further include a bracket body 320 extending from the coupling portion 310. The bracket body 320 may extend from the coupling portion 310 in a horizontal direction.

The coupling portion 310 may include one or more coupling holes 312. A coupling member may be coupled to the cabinet 10 through the coupling holes 312.

The hinge bracket 30 may include a shaft 350. The shaft 350 may include a first shaft 352 for the first door 21 and a second shaft 354 for the second door 22. Alternatively, the second shaft 354 may be omitted.

For example, the shaft 350 may be coupled to the bracket body 320 or may be integrated with the bracket body 320.

The auto-closing device 40 according to this embodiment may provide closing force to the first door 21 in a process of closing the first door 21 while acting with the hinge bracket 30. Alternatively, the auto-closing device 40 may provide the closing force to the second door 22.

In order for the auto-closing device 40 to provide the closing force to the first door 21, the auto-closing device 40 may be installed in the first door 21. For example, the auto-closing device 40 may be installed at a lower side of the first door 21.

For example, the first door 21 may include a door frame 210 that defines an outer appearance, and a front panel 214 provided on a front surface of the door frame 210.

The door frame 210 may include, for example, a lower cap 212. The auto-closing device 40 may be installed on the lower cap 212.

For example, the first door 21 may be provided with a recessed accommodation portion 216.

The auto-closing device 40 may be coupled to the first door 21 by a coupling member S1 in a state of being accommodated in the accommodation portion 216.

In the state in which the auto-closing device 40 is accommodated in the accommodation portion 216, a portion of the auto-closing device 40 may protrude downward from a bottom surface of the first door 21 so as to interact with the hinge bracket 30.

When the auto-closing device 40 is installed at the lower side of the first door 21, a shielding wall 218 may be provided on the first door 21 to restrict exposure of the auto-closing device 40 to the outside. The shielding wall 218 may be disposed in front of the auto-closing device 40.

The refrigerator according to this embodiment may further include a damping mechanism 50.

The damping mechanism 50 may generate damping force when the refrigerator door 20 is closed.

In this embodiment, the damping mechanism 50 may be provided on the door on which the auto-closing device 40 is mounted. In FIG. 3, it is disclosed that the damping mechanism 50 is provided on the first door 21 as an example.

In this specification, the damping mechanism 50 may reduce a closing speed of the first door 21 in a section in which the first door 21 is automatically closed by the auto-closing device 40.

In this embodiment, the damping mechanism 50 may operate in conjunction with the auto-closing device 40. For example, the damping mechanism 50 may operates in conjunction with the auto-closing device 40 to provide damping force the first door 21 when the first door 21 is automatically closed by the auto-closing device 40.

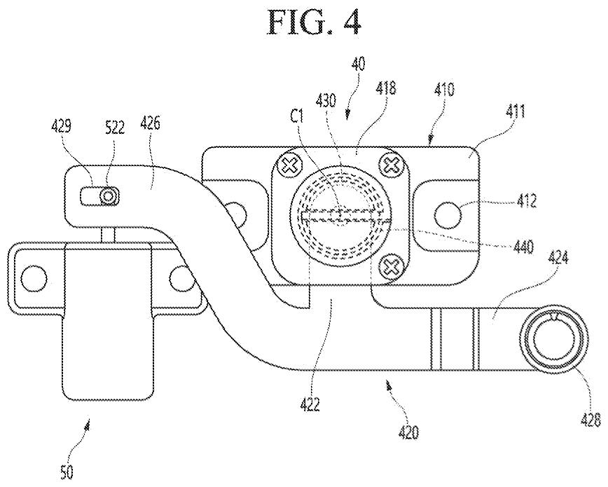

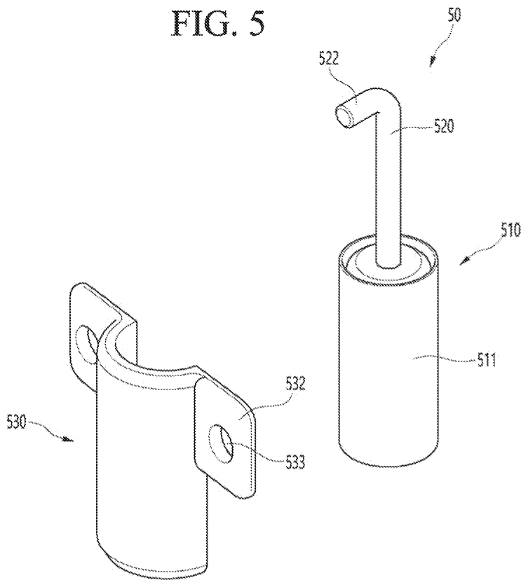

FIG. 4 is a view illustrating a state in which the auto-closing device and the damping mechanism are connected to each other according to the first embodiment, and FIG. 5 is a view illustrating the damping mechanism and a cover member according to the first embodiment.

Referring to FIGS. 3 to 5, the auto-closing device 40 according to this embodiment may include a case 410.

At least a portion of the case 410 may be accommodated in the accommodation portion 216.

The case 410 may include one or more extension portions 411. A coupling hole 412 may be defined in each of the extension portion 411. The coupling member S1 may pass through the coupling hole 412 and be coupled to the first door 21.

The auto-closing device 40 may further include a lever 420 that is movable with respect to the case 410.

The lever 420 may be rotatably connected to the case 410. That is, the case 410 may be a fixed member, and the lever 420 may be a movable member.

The auto-closing device 40 may further include an elastic member 440.

The elastic member 440 may be accommodated in the case 410.

The elastic member 440 may be connected to the lever 420. The elastic member 440 may be directly connected to the lever 420 or may be connected to the lever 420 through a separate member.

Referring to FIG. 4, the elastic member 440 may be connected to the lever 420 by, for example, a connector 430. The connector 430 may be coupled to the lever 420 to rotate together with the lever 420.

The elastic member 440 may be, for example, a torsion spring.

One end of the elastic member 440 may be fixed to the case 410, and the other end may be connected to the connector 430.

When the lever 420 rotates in one direction in a state in which one end of the elastic member 440 is fixed, the other end of the elastic member 440 connected to the connector 430 may rotate in the one direction.

When the other end of the elastic member 440 rotates in the one direction, the elastic member 440 accumulates elastic force. The elastic force accumulated by the elastic member 440 may act to the lever 420 so that the lever 420 rotates in another direction opposite to the one direction.

The lever 420 may include a first body 422. The first body 422 may be connected to the elastic member 440 or connected to the connector 430.

A rotation center C1 of the lever 420 may pass through the first body 422.

The lever 420 may include a second body 424 extending from the first body 422 to one side. The second body 424 may be provided with a contact portion 428 that is in contact with the bracket body 320.

The contact portion 428 may be a portion of the second body 424 or may be coupled to the second body 424.

When the contact portion 428 is coupled to the second body 424, the contact portion 428 may be made of an elastically deformable material. Alternatively, the contact portion 428 may be rotatably coupled to the second body 424. For example, the contact portion 428 may be a roller.

The lever 420 may further include a third body 426 extending from the first body 422 to the other side. The third body 426 may extend in a direction that is away from the second body 424 with respect to the first body 422.

The auto-closing device 40 may further include a cover 418. The cover 418 may be coupled to the case 410 in the state in which the lever 420 is connected to the connector 430 or the elastic member 440. The case 410 or the cover 418 may include a slot that provides a path to enable rotation of the lever 420.

The damping mechanism 50 may include a damper 510.

In this embodiment, the damper 510 may be used in various types. For example, the damper 510 may generate damping force due to resistance when oil flows therein. Thus, the damper 510 may be called a hydraulic damper or an oil damper.

The damper 510 may include a housing 511 and a rod 520 that is movably provided in the housing 511. A portion of the rod 520 may be disposed outside the housing 511, and the other portion may be disposed inside the housing 510. Within the housing 510, the rod 520 may be connected to a piston.

Oil may be provided in a buffer space inside the housing 511, and the piston may move within the buffer space. A spring supporting the piston may be provided in the buffer space. Alternatively, the spring may be omitted.

An end of the rod 520 may be provided with a connection portion 522 connected to the lever 420. The connection portion 522 may be provided by bending a portion of the rod 520. In this embodiment, the rod 520 may be a movable member, and the housing 510 may be a fixed member.

The connection portion 522 may be connected to the lever 420. For example, the connection portion 522 may be connected to the third body 426. The third body 426 may be provided with a slot 429 to which the connection portion 522 is connected.

The connection portion 522 may pass through the slot 429. The lever 420 may rotate, and the rod 520 may move linearly. To transmit rotational force of the lever 420 to the rod 520, the slot 429 may be provided to be larger than the connection portion 522. Thus, during the rotation of the lever 420, the connection portion 522 may move within the slot 429.

A portion of the lever 420 may be disposed between the damper 510 and a rotation center of the lever 420.

The damping mechanism 50 may further include a fixing bracket 530 that fixes the damper 510 to the first door 21.

The fixing bracket 530 may include one or more extension portions 532. A coupling hole 533 may be defined in each of the extension portion 532. The coupling member may pass through the coupling hole 533 and be coupled to the first door 21.

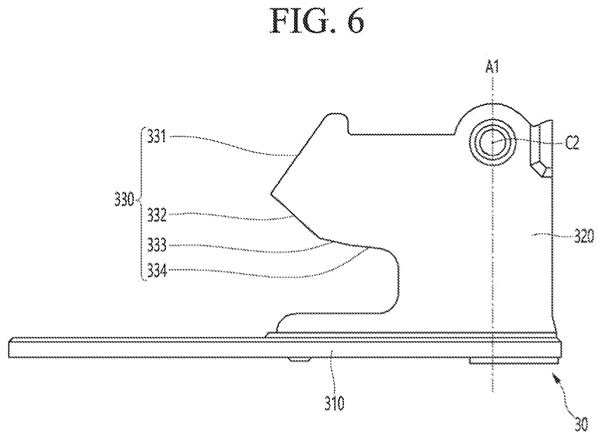

FIG. 6 is a bottom view of the hinge bracket according to the first embodiment.

Referring to FIG. 6, the bracket body 320 may include a contact surface 330 that is in contact with the lever 420.

The contact portion 428 of the lever may be in contact with the contact surface 330.

When an opening angle (or closing angle) of the first door 21 is within a set angle, the contact portion 428 may be in contact with the contact surface 330. In the process of opening or closing the first door 21 within an angle range less than the set angle, the contact portion 428 may move along the contact surface 330.

While the contact portion 428 moves along the contact surface 330, the lever 420 may rotate.

The contact surface 330 may include a first part 331. The first part 331 may be a portion at which the contact portion 428 initially contacts during the process of closing the first door 21.

Thus, in a state in which the first door 21 is opened at an angle greater than the set angle, the contact portion 428 is not in contact with the first part 331. When the opening angle of the first door 21 is less than or equal to the set angle, the contact portion 428 may be in contact with the first part 331.

The first part 331 may be not only inclined with respect to the coupling portion 310 (or the front surface of the cabinet 10), but also be inclined with respect to a virtual line A1 that is perpendicular to the coupling portion 310 while passing through a rotation center C2 of the first door 21.

The first part 331 may be inclined in a direction that is away from the virtual line A1 as it approaches the coupling portion 310.

The contact surface 330 may further include a second part 332 extending from the first part 331.

The first part 331 may include a start point and an end point. The second part 332 may include a start point and an end point.

The end point of the first part 331 may be the start point of the second part 332. The second part 332 may be inclined with respect to the first part 331.

The second part 332 may be inclined in a direction that is closer to the virtual line A1 as it approaches the coupling portion 310.

A distance from a rotation center C2 of the first door 21 to the end point of the first part 331 may be greater than that from the rotation center C2 of the first door 21 to the start point of the first part 331.

A length of the first part 331 may be greater than that of the second part 332.

The contact surface 330 may further include a third part 333 extending from the second part 331.

The third part 333 may include a start point and an end point. The end point of the second part 332 may be the start point of the third part 333.

A distance from the rotation center C2 of the first door 21 to the end point of the second part 332 may be less than that from the rotation center C2 of the first door 21 to the start point of the second part 332.

The distance from the rotation center C2 of the first door 21 may decrease as the second part 332 moves from the start point toward the end point.

A distance from the rotation center C2 of the first door 21 to the end point of the third part 333 may be less than that from the rotation center C2 of the first door 21 to the start point of the third part 333.

The distance from the rotation center C2 of the first door 21 may decrease as the third part 333 moves from the start point toward the end point.

A length of the third part 333 may be less than that of the second part 332. Each of the second part 332 and the third part 333 may be inclined with respect to the coupling portion 310.

An inclined angle of the second part 332 with respect to the coupling portion 310 may be greater than that of the third part 333 with respect to the coupling portion 310.

The third part 333 may be inclined in a direction that is closer to the virtual line A1 as it approaches the coupling portion 310.

The bracket body 320 may further include a fourth part 434 extending from the third part 333. The fourth part 434 may define an accommodation groove in which the contact portion 428 is accommodated.

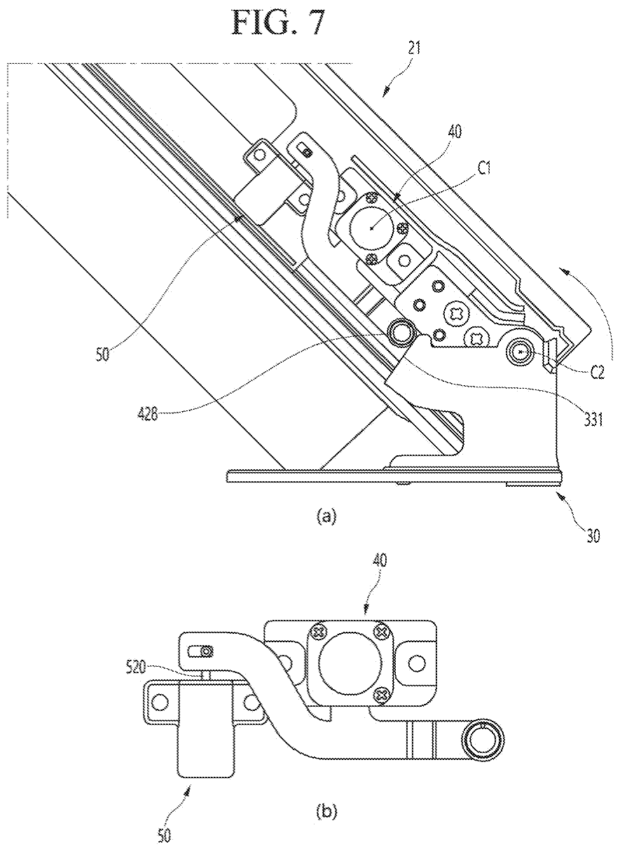

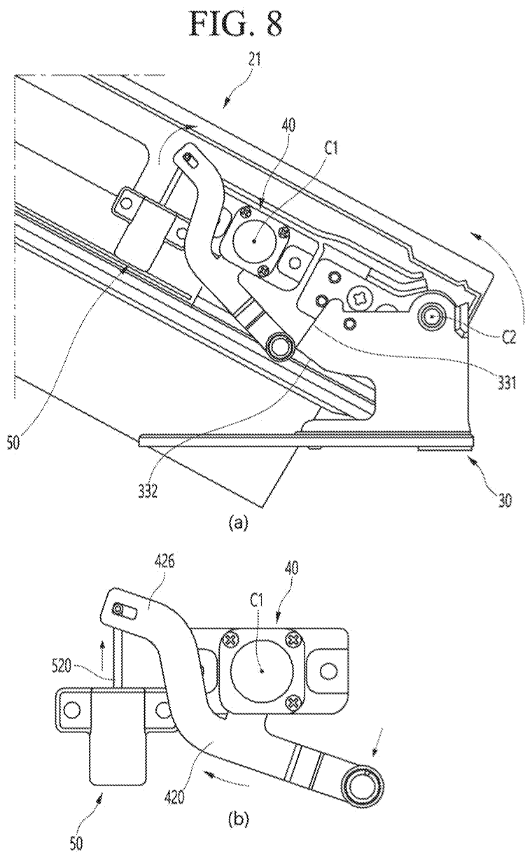

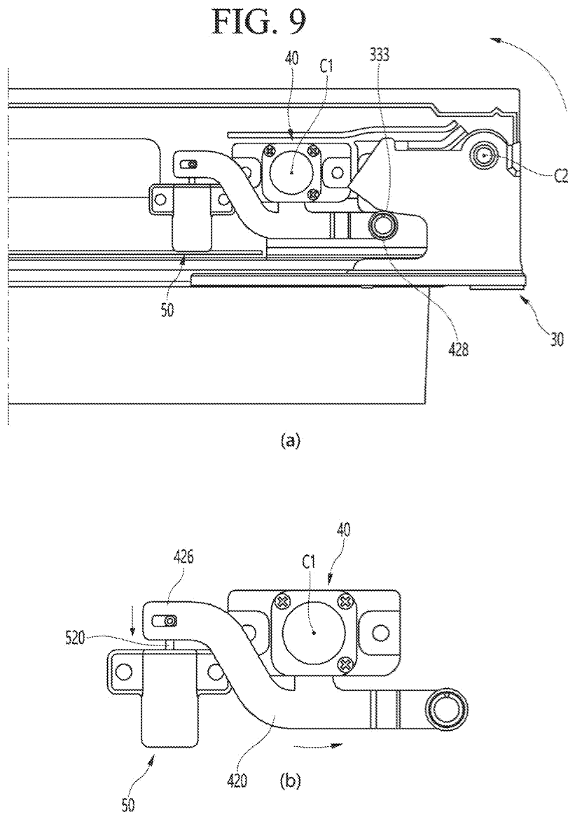

FIG. 7 is a view illustrating a state in which the contact portion of the lever is in contact with the first part in a state in which the closing angle of the first door is the set angle according to the first embodiment, FIG. 8 is a view illustrating a state in which the closing angle of the first door of FIG. 7 is reduced, and thus, the contact portion is disposed at a boundary between the first part and a second part, and FIG. 9 is a view illustrating a state in which the first door is closed according to the first embodiment.

In (b) of FIG. 7, a position of the rod (or connection portion) may be referred to as a first position, and in (b) of FIG. 8, a position of the rod (or connection portion) may be referred to as a second position.

Referring to FIGS. 7 to 9, when the lever 420 is spaced apart from the bracket body 320 in the process of closing the first door 21 after the first door 21 is opened, external force may not act on the lever 420.

In the process of closing the first door 21 in the first direction (counterclockwise direction in the drawing), when the first door 21 is angled at the set angle with the front of the cabinet 10, the contact portion 428 of the lever 420 may be in contact with the first part 331 of the contact surface 330.

At the point when the contact portion 428 is in contact with the contact surface 330, the rod 520 may be maintained at the first position.

When the first door 21 additionally rotates in the first direction in the state in which the contact portion 428 is in contact with the first part 331, the lever 420 may move by the inclination of the first part 331 may rotate in a second direction (clockwise direction in FIG. 8), which is opposite to the first direction.

That is, in the process of closing the first door 21, the first part 331 may apply resistance force to the lever 420 to allow the lever 420 to rotate in the second direction.

When the lever 420 rotates in the second direction, the other end of the elastic member 440 may rotate in the second direction so that the elastic member 440 accumulates the elastic force.

In the process of closing the first door 21, the elastic force accumulated in the elastic member 440 may increase as the contact portion 428 of the lever 420 moves from the start point to the end point of the first part 331.

In the process of allowing the lever 420 to rotate in the second direction, rotational force of the lever 420 may be transmitted to the connection portion 522 of the rod 520, and thus, the rod 520 may move in a third direction from the first position. For example, the rod 520 may move linearly in the third direction. The third direction may be a direction that is away from the coupling portion 310.

In the process of closing the first door 21, when the contact portion 428 of the lever 420 reaches the end point of the first part 331, the rod 520 reaches the second position. The second position of the rod 520 may be, for example, an initial position. The damping force that is capable of being applied when the rod 520 is disposed at the initial position may be maximum.

The elastic force of the spring provided in the damping mechanism 50 may be less than the elastic force of the elastic member 440 of the auto-closing device 40.

Thus, when the first door 21 is opened at an angle greater than the set angle, the rod 520 may be maintained at the first position by the elastic force of the elastic member 440.

When the lever 420 is in contact with the second part 332 in the process of closing the first door 21, the lever 420 rotates in the first direction. When the lever 420 rotates in the first direction, the elastic force accumulated in the elastic member 440 decreases.

When the contact portion 428 is separated from the first part 331 in the process of closing the first door 21, the resistance applied to the lever 420 is removed.

Then, the elastic force accumulated in the elastic member 440 acts on the lever 420 to increase in rotation angle of the lever 420 in the first direction. Thus, the first door 21 may be automatically closed. That is, while the lever 428 moves along the second part 332, the elastic force accumulated in the elastic member 440 decreases. The decreasing elastic force acts as closing force of the first door 21.

While the contact portion 428 moves along the second part 332, the rotational force in the first direction of the lever 420 is transmitted to the connection portion 522 of the rod 520.

The rod 520 may move from the second position in a fourth direction that is opposite to the third direction.

In the process of allowing the rod 520 to move in the fourth direction, the damping force may act to the lever 420.

While the contact portion 428 moves along the second part 332, the auto-closing device 40 may provide the closing force to the first door 21, while the damping mechanism 50 may provide the closing force to the first door 21.

According to this embodiment, the first door 21 may be automatically closed by the auto-closing device 40 during the process of closing the first door 21. In the section in which the first door 21 is automatically closed by the auto-closing device 40, the first door 21 may be closed smoothly by the damping force of the damping mechanism 50.

Just before the first door 21 is completely closed, the contact portion 428 passes through the end point of the second part 332.

In this case, since the inclined angle of the third part 333 with respect to the coupling portion 310 is less than that of the second part 332, while the contact portion 428 moves from the second part 332 to the third part 333, an angular velocity of the lever 20 due to the elastic force of the elastic member 440 may increase, and thus, the first door 21 may be completely closed. When the first door 21 is closed, the rod 520 is disposed at the first position.

In summary, when the first door 21 is closed, the elastic force may be accumulated in the elastic member 440 to be maximized while the contact portion 428 moves along a partial section of the contact surface 330, and thus, the damping force may not act in the partial section.

In another section of the contact surface 330, the elastic force of the elastic member 440 may act to the lever 420 to automatically close the first door 21 (automatic closing section), and while the first door 21 is automatically closed, the closing speed of the first door 21 may be reduced due to the damping force.

According to this embodiment, the door may be automatically closed by the auto-closing device during the door closing process, and also, the closing speed of the door may be reduced by the damping force of the damping mechanism when the door is closed, thereby mitigating the impact.

In addition, there is an advantage that the impact is reduced by the damping mechanism during the door closing process, and the resistance of the damping mechanism does not act when the door is opened.

In addition, the auto-closing device may be installed even if a thickness of the door is small, and the damping mechanism may operate in conjunction with this structure, and thus, there is an advantage that the impact is reduced during the door closing process.

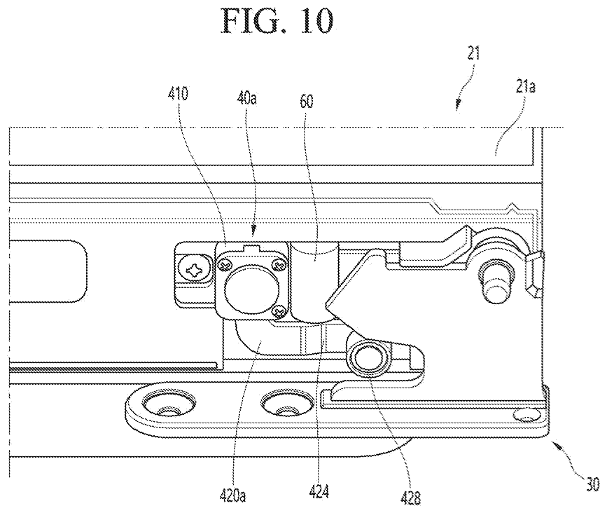

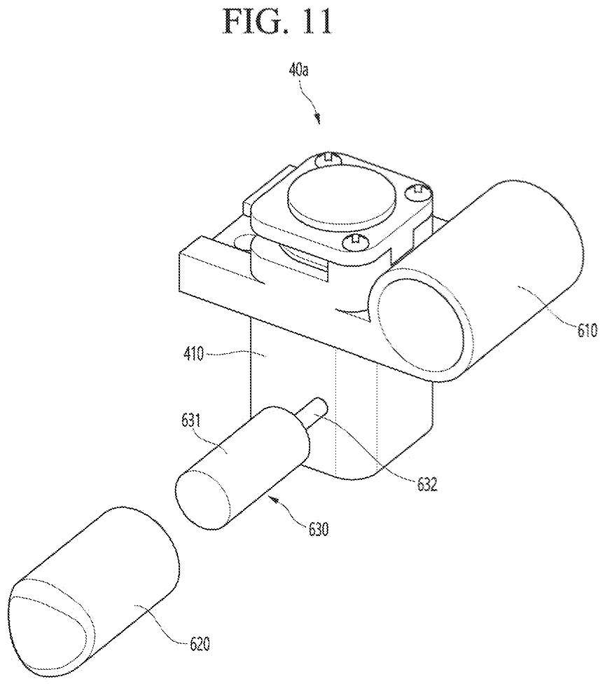

FIG. 10 is a view illustrating a configuration in which an auto-closing device and a damping mechanism are installed in a first door according to a second embodiment, and FIG. 11 is a view illustrating a state in which a portion of the damping mechanism is separated from the auto-closing device.

This embodiment is the same as the first embodiment in other respects, except that there is a difference in shape and installation position of a damping mechanism. Thus, only characterized portions in the present embodiment will be described below.

Referring to FIGS. 10 and 11, an auto-closing device 40a according to this embodiment may be integrated with a damping mechanism 60. Alternatively, the damping mechanism 60 may be mounted on the auto-closing device 40a.

The damping mechanism 60 may include an outer body 610 and a damper 630 accommodated in the outer body 610. The outer body 610 may be integrated with the case 410 of the auto-closing device 40a or may be coupled to the case 410.

The damper 630 may include a housing 631 and a rod 632 that is movable relative to the housing 631.

The rod 632 may be fixed to the outer body 610. The housing 631 may move with respect to the outer body 610 while being accommodated in the outer body 610.

The damping mechanism 60 may further include a contact member 620 that is coupled to the housing 631 of the damper 630 to moves together with the housing 631.

The contact member 620 may surround the damper 630. Alternatively, the contact member 620 may be coupled to the housing 631 at a position at which the contact member 620 is in contact the lever 420a of the auto-closing device 40a. Alternatively, the contact member 620 may be integrated with the housing 631. Alternatively, the contact member 620 may be omitted.

In this embodiment, the lever 420a may have a form in which a third body is omitted from the lever 420 according to the first embodiment.

For example, the lever 420a may include a first body 422 and a second body 424. The damping mechanism 60 may be in contact with, for example, the second body 424.

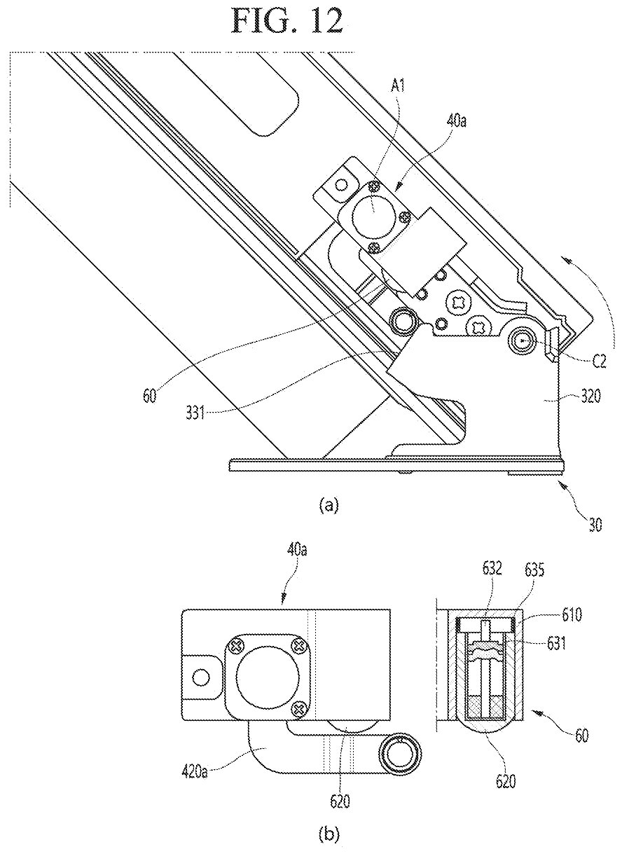

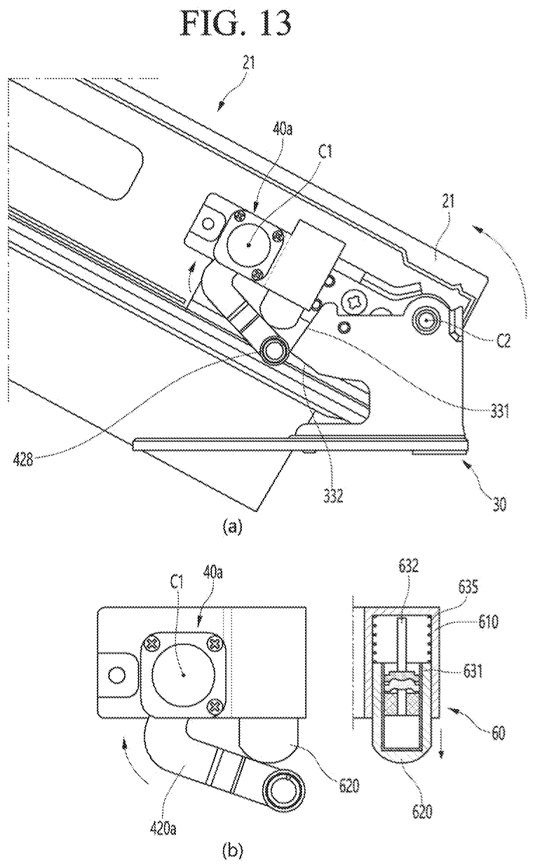

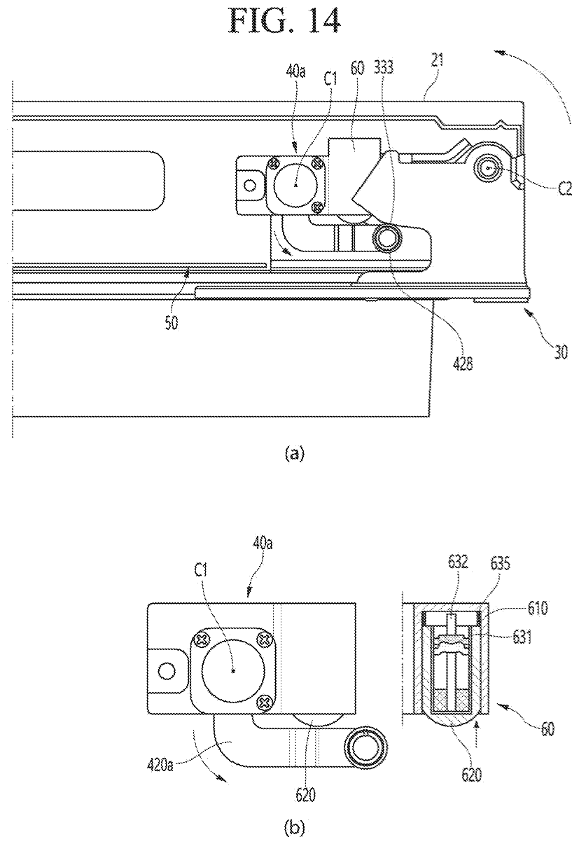

FIG. 12 is a view illustrating a state in which a contact portion of a lever is in contact with a first part in a state in which a closing angle of the first door is a set angle according to the second embodiment, FIG. 13 is a view illustrating a state in which the closing angle of the first door of FIG. 12 is reduced, and thus, the contact portion is disposed at a boundary between the first part and a second part, and FIG. 14 is a view illustrating a state in which the first door is closed according to the second embodiment.

In (b) of FIG. 12, a position of the contact member (or damper) may be referred to as a first position, and in (b) of FIG. 13, a position of the contact member (or damper) may be referred to as a second position.

Referring to FIGS. 12 to 14, the damping mechanism 60 may be disposed between a rotation center C1 of the lever 420a and a rotation center C2 of the first door 21.

If the lever 420a is separated from a bracket body 320 during a process of closing the first door 21 after the first door 21 is opened, no external force may act on the lever 420a.

In the process of closing the first door 21 in the first direction (counterclockwise direction in the drawing), when the first door 21 is angled at the set angle with the front of the cabinet 10, the contact portion 428 of the lever 420a may be in contact with the first part 331 of the contact surface 330.

At the point when the contact portion 428 is in contact with the contact surface 330, the damper 630 may be maintained at the first position.

The first position of the damper 630 may be in a state in which the lever 420a presses the damper 630. When the damper 630 is pressed, a spring 635 within the damper 630 may be contracted.

When the first door 21 additionally rotates in the first direction in the state in which the contact portion 428 is in contact with the first part 331, the lever 420a may move by the inclination of the first part 331 may rotate in a second direction (clockwise direction in FIG. 13), which is opposite to the first direction.

That is, in the process of closing the first door 21, the first part 331 may apply resistance force to the lever 420a to allow the lever 420a to rotate in the second direction.

When the lever 420a rotate in the second direction, the other end of the elastic member 440 rotates in the second direction so that the elastic member 440 accumulates elastic force.

In the process of closing the first door 21, the elastic force accumulated in the elastic member 440 increases as the contact portion of the lever 420a moves from a start point to an end point of the first part 331.

In the process of rotating the lever 420a in the second direction, the pressing force of the lever 420a with respect to the damper 630 decreases, and the damper 630 moves in the third direction by the spring 635.

The third direction may be a direction approaching the coupling portion 310. The third direction may be a direction in which a protruding length of the housing 631 from the outer body 610 increases. The housing 520 may move linearly in the third direction.

In the process of closing the first door 21, when the contact portion 428 of the lever 420a reaches the end point of the first part 331, the damper 630 reaches the second position. For example, the second position of the damper 620 may be an initial position. When the damper 620 is disposed at the initial position, the damping force that is capable of being applied may be maximum.

The elastic force of the spring 635 provided in the damping mechanism 60 may be less than the elastic force of the elastic member 440 of the auto-closing device 40.

Thus, when the first door 21 is opened at an angle greater than the set angle, the damper 630 may be maintained at the first position by the elastic force of the elastic member 440.

When the lever 420a is in contact with the second part 332 in the process of closing the first door 21, the lever 420a rotates in the first direction. When the lever 420a rotates in the first direction, the elastic force accumulated in the elastic member 440 decreases.

When the contact portion 428 is deviated from the first part 331 in the process of closing the first door 21, resistance applied to the lever 420a is removed.

Then, the elastic force accumulated in the elastic member 440 acts on the lever 420a to increase in rotation angle of the lever 420a in the first direction. Thus, the first door 21 may be automatically closed. That is, while the lever 428 moves along the second part 332, the elastic force accumulated in the elastic member 440 decreases. The decreasing elastic force acts as closing force of the first door 21.

While the contact portion 428 moves along the second part 332, the rotational force in the first direction of the lever 420a is transmitted to the damper 630.

The damper 630 may be pressed by the lever 420a to move from the second position in a fourth direction opposite to the third direction.

While the damper 630 moves in the fourth direction, damping force may act to the lever 420a.

While the contact portion 428 moves along the second part 332, the auto-closing device 40a may provide the closing force to the first door 21, while the damping mechanism 60 may provide the closing force to the first door 21.

According to this embodiment, the first door 21 may be automatically closed by the auto-closing device 40a during the process of closing the first door 21, and the first door 21 may be smoothly closed by the damping force of the damping mechanism 60 in the section in which the first door 21 is automatically closed by the auto-closing device 40a.

Just before the first door 21 is completely closed, the contact portion 428 passes through the end point of the second part 332. In this case, since the inclined angle of the third part 333 with respect to the coupling portion 310 is less than that of the second part 332, while the contact portion 428 moves from the second part 332 to the third part 333, an angular velocity of the lever 420a due to the elastic force of the elastic member 440 may increase, and thus, the first door 21 may be completely closed. When the first door 21 is closed, the damper 630 is disposed at the first position.

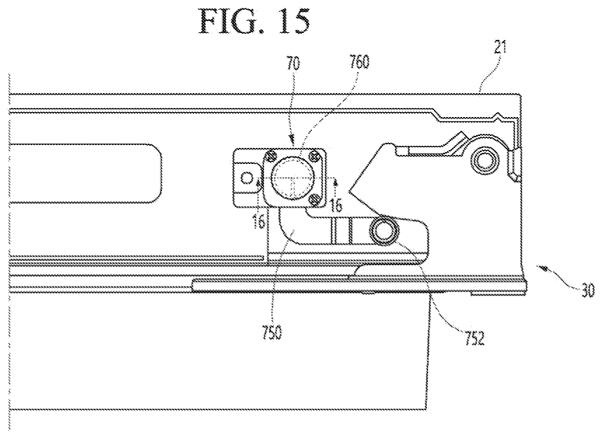

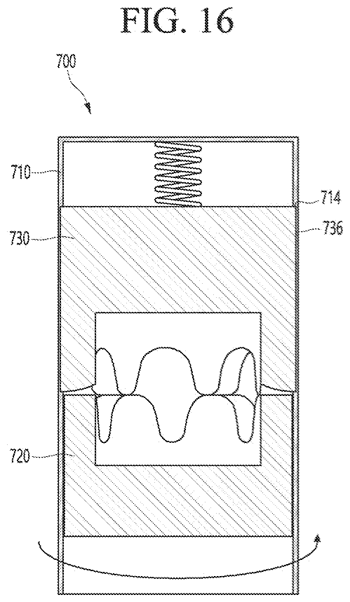

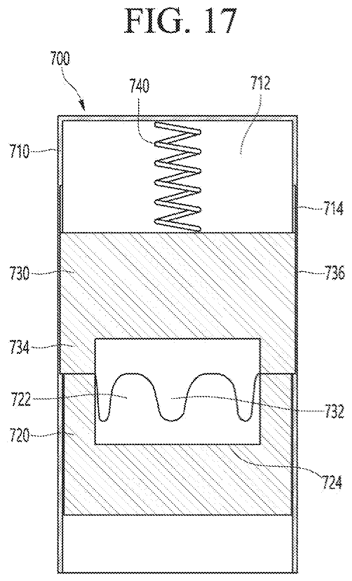

FIG. 15 is a bottom view of a first door according to a third embodiment. FIG. 16 is a cross-sectional view taken along line 16-16 of FIG. 15. FIG. 17 is a view illustrating a state in which a first member rotates in FIG. 16.

Referring to FIGS. 15 to 17, an auto-closing device 70 according to this embodiment may not only provide closing force to the first door, but also provide damping force.

The auto-closing device 70 may include a case 710. The case 710 may be accommodated in a first door 21.

The auto-closing device 70 may include a first member 720 accommodated in the case 710. The auto-closing device 70 may include a lever 750 connected to the first member 720.

The lever 750 or the first member 720 may be connected to, for example, an elastic member 760. One end of an elastic member 760 may be fixed to the case 710, and the other end may be connected to the lever 750 or the first member 720.

A shape and function of the lever 750 may be the same as the lever described in the previous embodiment, and thus, detailed descriptions may be omitted.

The first member 720 may rotate within the case 710. The first member 720 may rotate within the case 710. A rotational center of the first member 720 may be the same as the rotational center of the lever 750.

The auto-closing device 70 may further include a second member 730 accommodated in the case 710. The second member 730 may be in contact with the first member 720. The second member 730 may move linearly within the case 710 when the first member 720 rotates. For example, based on FIG. 16, the second member 730 may move vertically.

The first member 720 may include a first space 724 capable of accommodating oil. The second member 730 may include a second space 734 that is capable of accommodating oil.

For example, the first space 724 may be depressed in a direction that is away from the second member 730. For example, the second space 734 may be depressed in a direction that is away from the first member 730.

To enable the linear movement of the second member 730 when the first member 720 rotates, the first member 720 may include a first uneven portion 722, and the second member 730 may include a second uneven portion 732.

The first uneven portion 722 may include a plurality of concave portions and a plurality of convex portions, which are disposed alternately. The second uneven portion 732 may include a plurality of concave portions and a plurality of convex portions, which are disposed alternately.

Depending on the rotational position of the first member 720, the convex portion of the first uneven portion 722 may be accommodated in the concave portion of the second uneven portion 732. The convex portion of the second uneven portion 732 may be accommodated in the concave portion of the first uneven portion 732.

The auto-closing device 70 may further include a support body 740 that supports the second member 730. For example, the support body 740 may be an elastic member that elastically supports the second member 730.

The second member 730 and the case 710 may define a buffer space 712 in which oil is accommodated. The support body 740 may be disposed in the buffer space 712.

Although not shown, the case 710 may be provided with a rotation guide that guides the rotation of the first member 720.

A protrusion 736 extending in a longitudinal direction of the second member 730 (or an arrangement direction of the first member and the second member) may be disposed on the second member 730. A protrusion groove 714 in which the protrusion 736 is accommodated may be defined in an inner circumferential surface of the case 710.

While the protrusion 736 is accommodated in the protrusion groove 714, the protrusion 736 may move along the protrusion groove 714. The rotation of the second member 730 may be restricted by the protrusion groove 714 and the protrusion 736, and the linear movement may be stably performed.

The first member 720 may rotate in both directions within the case 710.

In this embodiment, the first member 720, the second member 730, and the elastic member 740, which are disposed within the case 710, may be referred to as a damping mechanism. That is, the damping mechanism may be disposed inside the auto-closing device.

In FIG. 16, a position of the second member may be referred to as a first position. A position of the second member in FIG. 17 may be referred to as a second position.

The damping force may be generated while the second member 730 moves from the second position to the first position.

When the second member 730 moves in the third direction from the second position to the first position, the support body 740 may be contracted, and the oil in the buffer space 712 may pass through the second member 730 or flow into the first space 724 or the second space 724 through a space between the second member 730 and the inner circumferential surface of the case 710.

The damping force may be generated in the process of oil flowing from the buffer space 712 to the first space 724 or the second space 724.

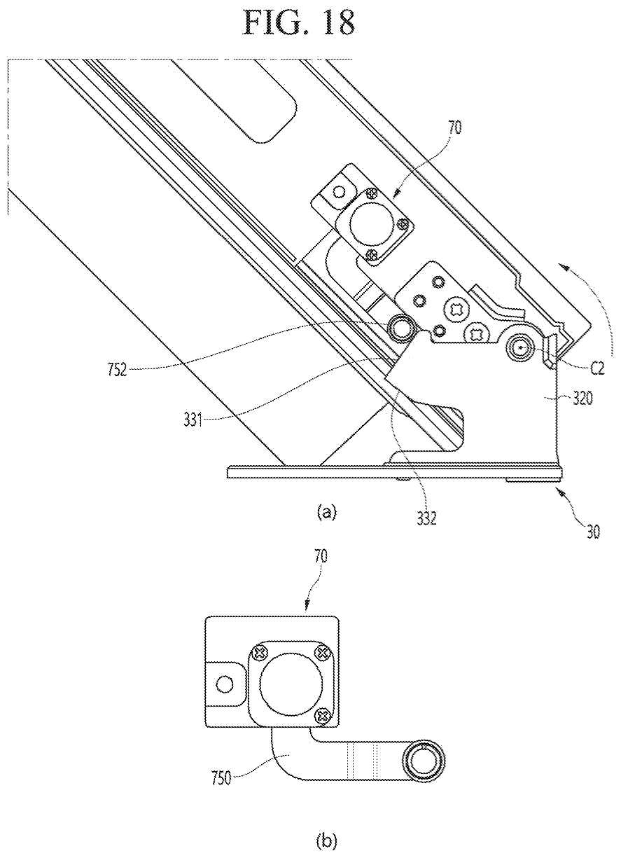

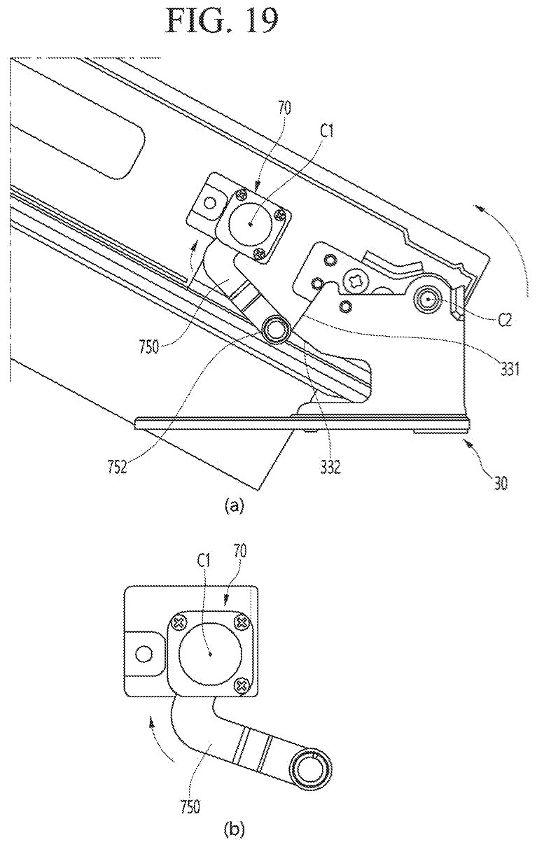

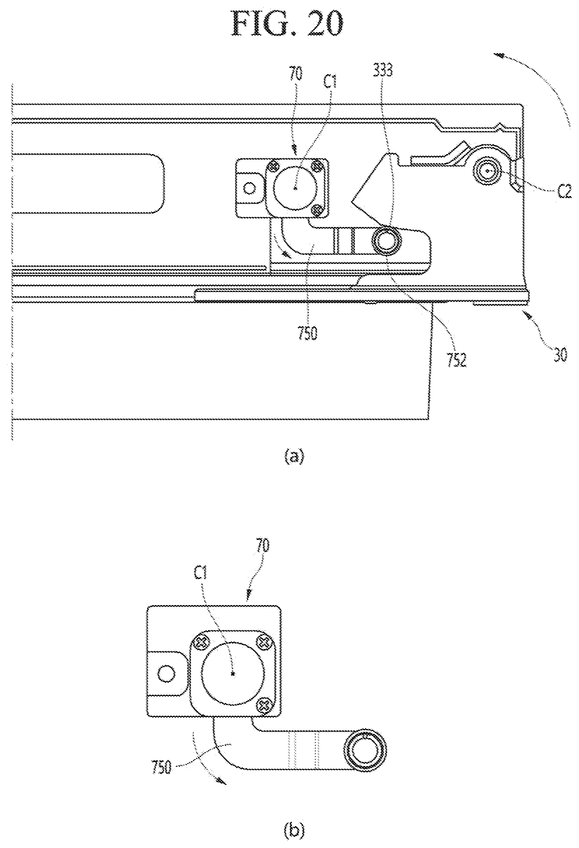

FIG. 18 is a view illustrating a state in which the contact portion of the lever is in contact with the first part in a state in which a closing angle of the first door is a set angle according to the third embodiment, FIG. 19 is a view illustrating a state in which the closing angle of the first door of FIG. 17 is reduced, and thus, the contact portion is disposed at a boundary between the first part and a second part, and FIG. 20 is a view illustrating a state in which the first door is closed according to the third embodiment.

Referring to FIGS. 15 to 20, when the lever 750 is spaced apart from the bracket body 320 in the process of closing the first door 21 after the first door 21 is opened, external force may not act on the lever 750.

In a state in which no external force acts to the lever 750, the state in which the convex portion of the first uneven portion 722 and the convex portion of the second uneven portion 732 are in contact with each other may be maintained due to the elastic force of the elastic member 760. That is, the second member 730 may be disposed at the first position.

In the process of closing the first door 21 in the first direction (counterclockwise direction in FIG. 18), when the first door 21 is angled at the set angle with the front of the cabinet 10, the contact portion 752 of the lever 750 may be in contact with the first part 331 of the contact surface 330.

When the first door 21 additionally rotates in the first direction in the state in which the contact portion 752 is in contact with the first part 331, the lever 750 may move by the inclination of the first part 331 may rotate in a second direction (clockwise direction in FIG. 19), which is opposite to the first direction.

That is, in the process of closing the first door 21, the first part 331 may apply resistance force to the lever 750 to allow the lever 750 to rotate in the second direction.

When the lever 750 rotates in the second direction, the elastic member 760 rotates in the second direction so that the elastic member 760 accumulates elastic force.

In the process of closing the first door 21, the elastic force accumulated in the elastic member 760 may increase as the contact portion 752 of the lever 750 moves from the start point to the end point of the first part 331.

In the process of allowing the lever 750 to rotate in the second direction, the second member 730 moves in a direction that is closer to the first member 720 by the elastic force of the support body 740. That is, the second member 730 may move in a fourth direction, which is opposite to the third direction.

In the process of closing the first door 21, when the contact portion 752 of the lever 750 reaches an end point of the first part 331, the second member 720 moves to a second position.

The elastic force of the elastic member 760 may be greater than that of the support body 740.

Therefore, when the first door 21 is opened at an angle greater than a set angle, the second member 720 may be maintained at the first position by the elastic force of the elastic member 760.

With the second member 720 moves to the second position, when the lever 750 is in contact with the second part 332, the lever 750 rotates in the first direction. When the lever 750 rotates in the first direction, the elastic force accumulated in the elastic member 760 decreases.

When the contact portion 752 is separated from the first part 331 in the process of closing the first door 21, the resistance applied to the lever 750 is removed.

Then, the elastic force accumulated in the elastic member 760 acts on the lever 750 to increase in rotation angle of the lever 750 in the first direction. Thus, the first door 21 may be automatically closed. That is, while the lever 752 moves along the second part 332, the elastic force accumulated in the elastic member 760 decreases. The decreasing elastic force acts as closing force of the first door 21.

In the process of allowing the lever 750 to rotate in the first direction in the state in which the contact portion 752 is in contact with the second part 332, the second member 730 moves away from the first member 720, and thus, in this process, damping force is generated by the lever 750. That is, the second member 730 moves from the second position to the first position.

In the process of allowing the contact portion 752 to move along the second part 332, the elastic member 760 may provide the closing force, and in the process of allowing the second member 730 to move from the second position to the first position, the damping force may be provided to the first door 21 by a flow of oil.

Thus, according to this embodiment, the first door 21 may be automatically closed by the auto-closing device during the process of closing the first door 21, and the first door 21 may be smoothly closed by the damping force in the section in which the first door 21 is automatically closed by the auto-closing device 70.

When the first door 21 is closed, the second member 730 may move to the first position.

In the process of opening the first door 21, the first member 720 may rotate in a direction opposite to the rotation direction when the first door 21 is closed.

Even in the process of opening the first door 21, the second member 730 may move from the second position to the first position, and in this process, the damping force may be provided to the first door 21.

Thus, in the case of this embodiment, the damping force may not only act to the first door when the first door is closed, but also the damping force may act to the first door even in the process of opening the first door.

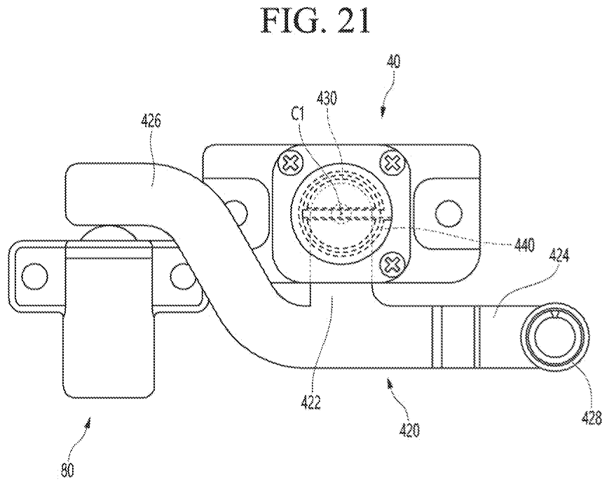

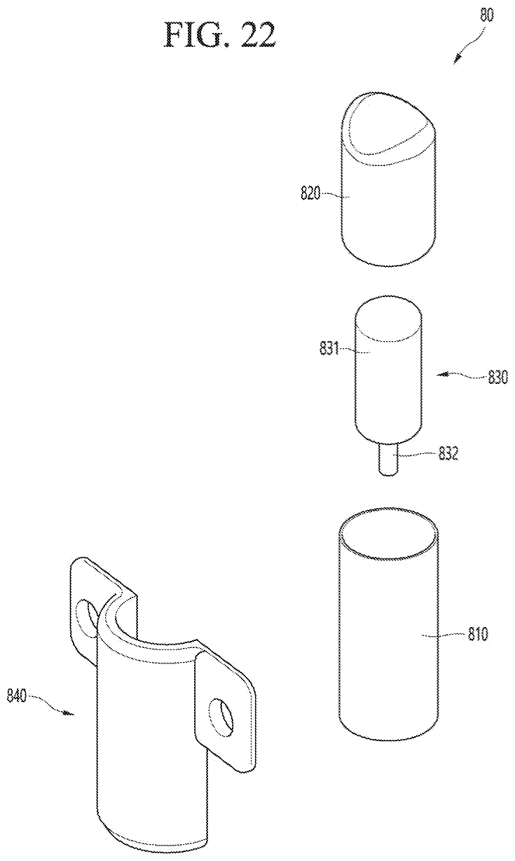

FIG. 21 is a view illustrating an arrangement of an auto-closing device and a damping mechanism according to a fourth embodiment, and FIG. 22 is a view illustrating the damping mechanism and a cover member according to the fourth embodiment.

This embodiment is the same as the first embodiment in other respects, except that a damping mechanism operates without being coupled to an auto-closing device. Thus, only characterized portions in the present embodiment will be described below.

Referring to FIGS. 21 and 22, unlike the first embodiment, a damping mechanism 80 may be in contact with one surface of a lever 420.

The damping mechanism 80 may include a damper 830 and a fixing bracket 840 for fixing the damper 830 to a first door 21.

The fixing bracket 840 may be coupled to the first door 21 at a position spaced apart from a case of an auto-closing device 40.

The damper 830 may include a housing 831 and a rod 832 that is movable relative to the housing 831.

The damping mechanism 80 may further include an outer body 810 that accommodates the damper 830. The rod 832 may be fixed to the outer body 810. The housing 831 may move with respect to the outer body 810 while being accommodated in the outer body 810.

The damping mechanism 80 may further include a contact member 820 that is coupled to the housing 831 of the damper 830 to move together with the housing 830. The contact member 820 may surround the damper 830. Alternatively, the contact member 820 may be coupled to the housing 831 at a position at which the contact member 620 is in contact the lever 420 of the auto-closing device 40. Alternatively, the contact member 820 may be omitted.

For example, the damping mechanism 80 may be in contact with a third body 426 of the lever 420. When the damping mechanism 80 includes a contact member 820, the contact member 820 may be in contact with the third body 426.

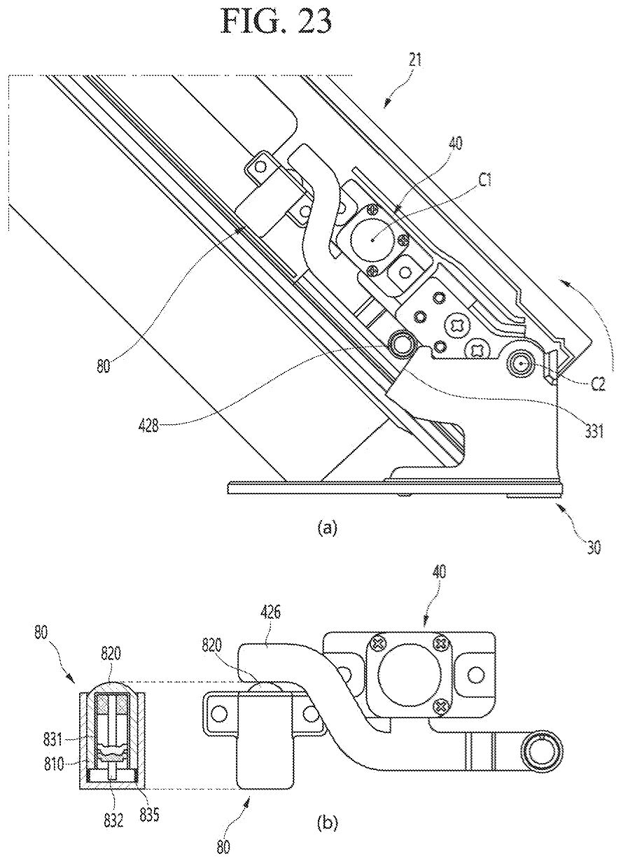

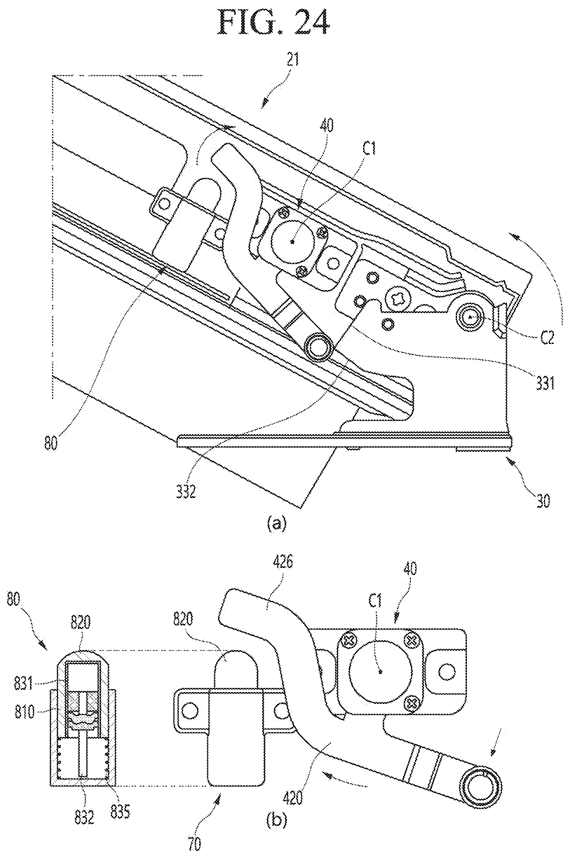

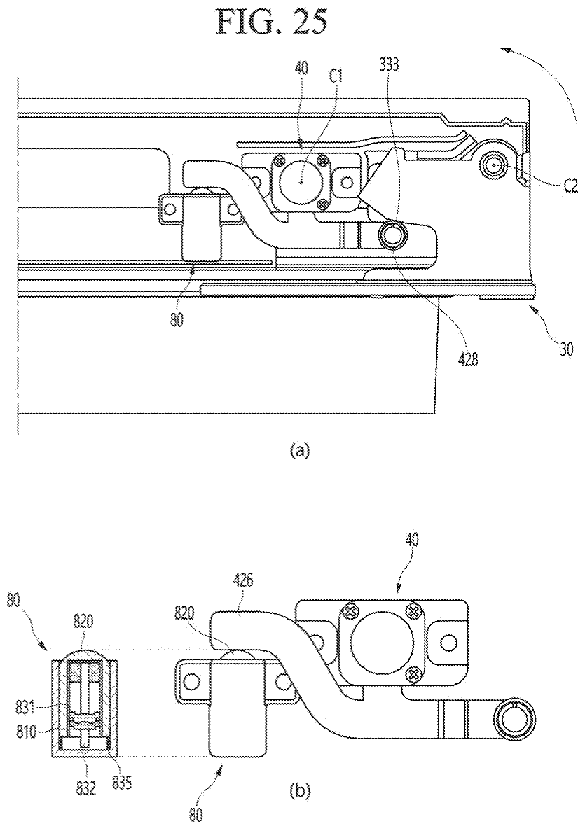

FIG. 23 is a view illustrating a state in which a contact portion of the lever is in contact with a first part in a state in which a closing angle of the first door is a set angle according to the fourth embodiment, FIG. 24 is a view illustrating a state in which the closing angle of the first door of FIG. 23 is reduced, and thus, the contact portion is disposed at a boundary between the first part and a second part, and FIG. 25 is a view illustrating a state in which the first door is closed according to the fourth embodiment.

In (b) of FIG. 23, a position of the damper (or contact member) may be referred to as a first position, and in (b) of FIG. 24, a position of the damper (or contact member) may be referred to as a second position.

Referring to FIGS. 21 to 25, when the lever 420 is spaced apart from the bracket body 320 in the process of closing the first door 21 after the first door 21 is opened, external force may not act on the lever 420.

In the process of closing the first door 21 in the first direction (counterclockwise direction in the drawing), when the first door 21 is angled at the set angle with the front of the cabinet 10, the contact portion 428 of the lever 420 may be in contact with the first part 331 of the contact surface 330.

At the point when the contact portion 428 is in contact with the contact surface 330, the damper 830 may be maintained at the first position.

The first position of the damper 830 may be in a state in which the lever 420 presses the damper 830. When the damper 830 is pressed, a spring 835 within the damper 830 may be contracted.

When the first door 21 additionally rotates in the first direction in the state in which the contact portion 428 is in contact with the first part 331, the lever 420 may move by the inclination of the first part 331 may rotate in a second direction (clockwise direction in FIG. 24), which is opposite to the first direction.

When the lever 420 rotates in the second direction, the other end of the elastic member 440 may rotate in the second direction so that the elastic member 440 accumulates the elastic force.

In the process of closing the first door 21, the elastic force accumulated in the elastic member 440 may increase as the contact portion 428 of the lever 420 moves from the start point to the end point of the first part 331.

In the process of rotating the lever 420 in the second direction, the pressing force of the lever 420 with respect to the damper 830 decreases, and the damper 830 moves in the third direction by the spring 835.

The third direction may be a direction that is away from the coupling portion 310. The third direction may be a direction in which a protruding length of the housing 831 from the outer body 810 increases. The housing 810 may move linearly in the third direction.

In the process of closing the first door 21, when the contact portion 428 of the lever 420 reaches the end point of the first part 331, the rod 832 reaches the second position. The second position of the rod 832 may be, for example, an initial position. The damping force that is capable of being applied when the rod 832 is disposed at the initial position may be maximum.

The elastic force of the spring 835 provided in the damping mechanism 80 may be less than the elastic force of the elastic member 440 of the auto-closing device 40.

Thus, when the first door 21 is opened at an angle greater than the set angle, the damper 830 may be maintained at the first position by the elastic force of the elastic member 440.

When the lever 420 is in contact with the second part 332 in the process of closing the first door 21, the lever 420 rotates in the first direction. When the lever 420 rotates in the first direction, the elastic force accumulated in the elastic member 440 decreases.

When the contact portion 428 is separated from the first part 331 in the process of closing the first door 21, the resistance applied to the lever 420 is removed.

Then, the elastic force accumulated in the elastic member 440 acts on the lever 420 to increase in rotation angle of the lever 420 in the first direction. Thus, the first door 21 may be automatically closed. That is, while the lever 428 moves along the second part 332, the elastic force accumulated in the elastic member 440 decreases. The decreasing elastic force acts as closing force of the first door 21.

While the contact portion 428 moves along the second part 332, the rotational force in the first direction of the lever 420 is transmitted to the damper 830.

The damper 830 may move from the second position in a fourth direction that is opposite to the third direction.

In the process of allowing the damper 830 to move in the fourth direction, the damping force may act to the lever 420.

While the contact portion 428 moves along the second part 332, the auto-closing device 40 may provide the closing force to the first door 21, while the damping mechanism 80 may provide the closing force to the first door 21.

Just before the first door 21 is completely closed, the contact portion 428 passes through the end point of the second part 332.

In this case, since the inclined angle of the third part 333 with respect to the coupling portion 310 is less than that of the second part 332, while the contact portion 428 moves from the second part 332 to the third part 333, an angular velocity of the lever 20 due to the elastic force of the elastic member 440 may increase, and thus, the first door 21 may be completely closed. When the first door 21 is closed, the damper 830 is disposed at the first position.

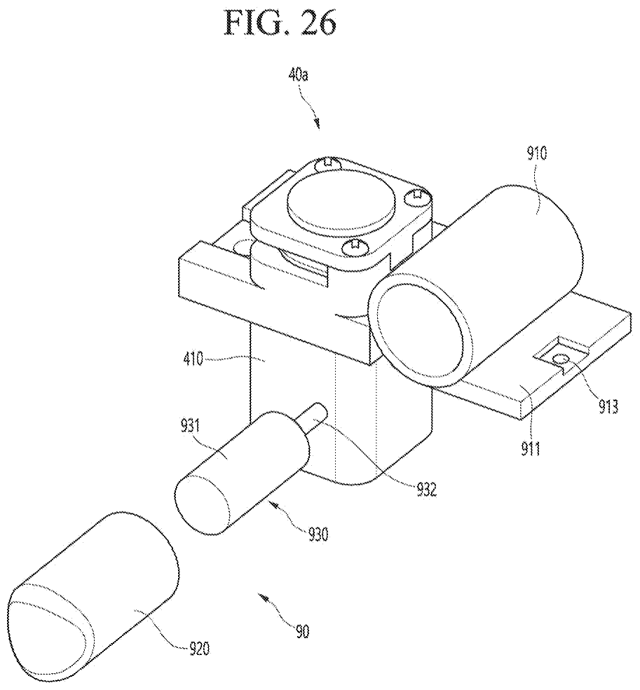

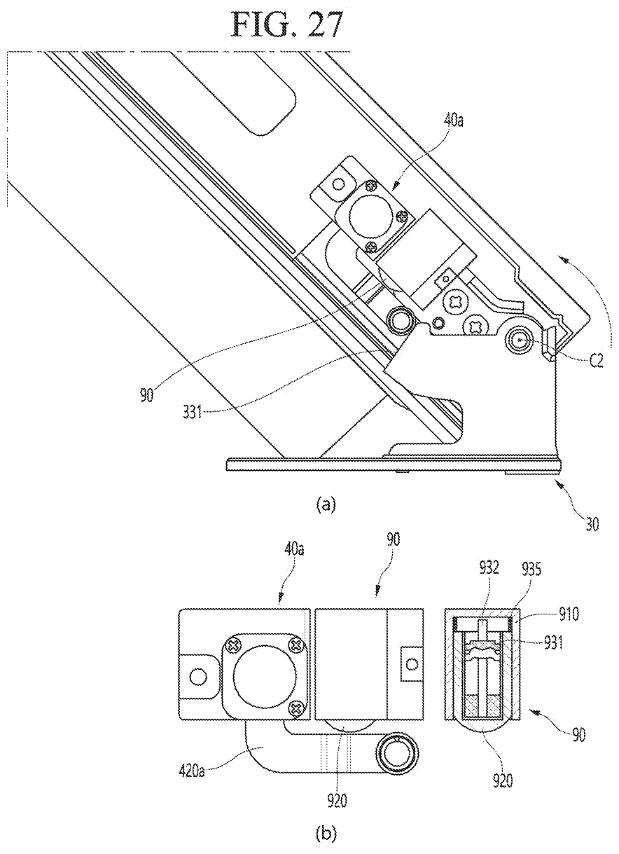

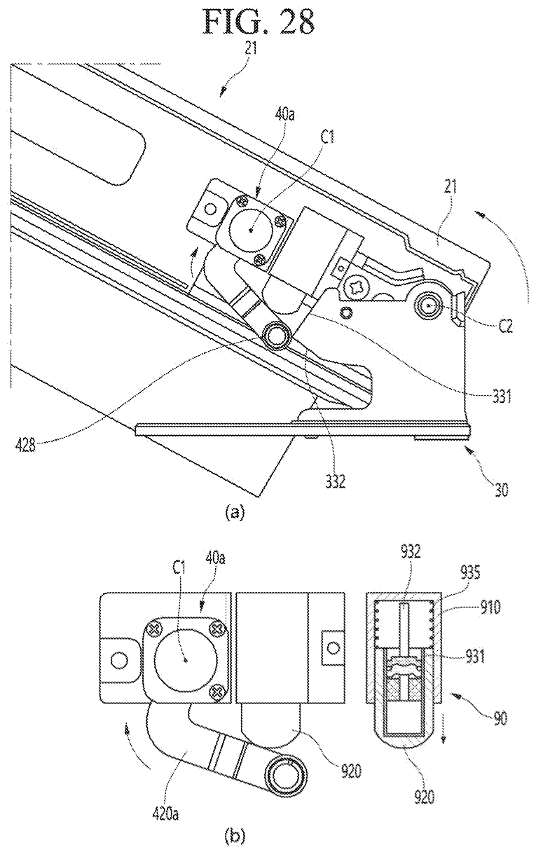

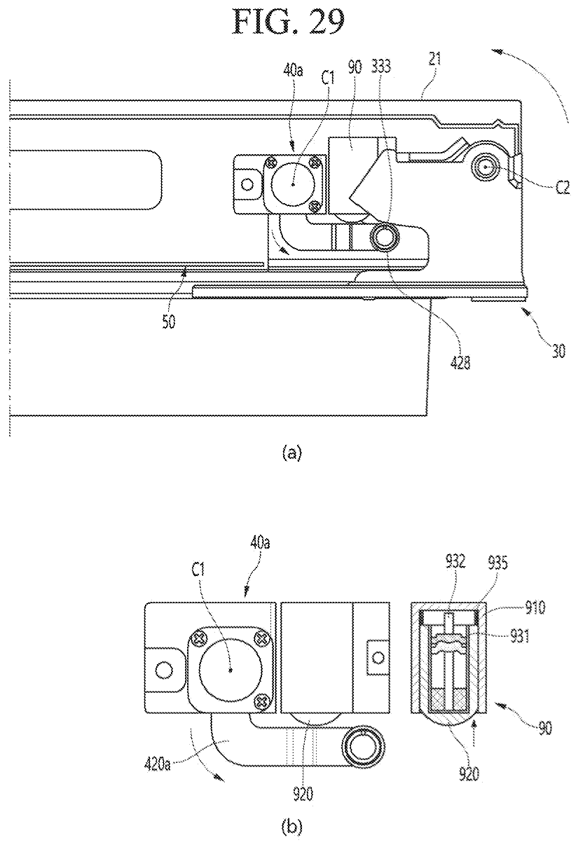

FIG. 26 is a view illustrating an auto-closing device and a damping mechanism according to a fifth embodiment. FIG. 27 is a view illustrating a state in which a contact portion of a lever is in contact with a first part in a state in which a closing angle of a first door is a set angle according to the fifth embodiment, FIG. 28 is a view illustrating a state in which the closing angle of the first door of FIG. 27 is reduced, and thus, the contact portion is disposed at a boundary between the first part and a second part, and FIG. 29 is a view illustrating a state in which the first door is closed according to the fifth embodiment.

This embodiment is the same as the second embodiment in other respects, except that the damping mechanism is fixed to a door in a separate state from the auto-closing device. Thus, hereinafter, only the characteristic portions of this embodiment will be described below.

Referring to FIGS. 26 to 29, a damping mechanism 90 may be disposed at one side of the auto-closing device 40a according to this embodiment. The damping mechanism 90 may be coupled to a first door 21 separately from the auto-closing device 40a.

The damping mechanism 90 may include an outer body 910 and a damper 930 accommodated in the outer body 910. The outer body 910 may be installed on the first door 21 at a position adjacent to a case of the auto-closing device 40a.

The outer body 910 may include a coupling portion 911 to be coupled to the first door 21. A coupling hole 912 through which the coupling member passes may be defined in the coupling portion 911.

The damper 930 may include a housing 931 and a rod 932 that is movable relative to the housing 931.

The rod 932 may be fixed to the outer body 910. The housing 931 may move with respect to the outer body 910 while being accommodated in the outer body 910.

The damping mechanism 90 may further include a contact member 920 that is coupled to the housing 931 of the damper 930 to move together with the housing 930.

The contact member 920 may surround the damper 930. Alternatively, the contact member 920 may be coupled to the housing 931 at a position at which the contact member 620 is in contact the lever 420a of the auto-closing device 40a. Alternatively, the contact member 920 may be omitted.

The operation and position of the auto-closing device and the damping mechanism in the process of closing the first door may be the same as those described in FIGS. 12 to 14 of the second embodiment, and thus, detailed descriptions will be omitted.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. A refrigerator comprising:
a cabinet having a storage space;
a door configured to open and close the cabinet;
a hinge bracket configured to connect the door to the cabinet to rotatably support the door;
an auto-closing device configured to provide a closing force to the door to assist in rotating the door towards a closed position, the auto-closing device being in contact with the hinge bracket during a portion of a rotation of the door; and
a damping mechanism configured to provide damping force to the door while the auto-closing device provides the closing force to the door.

2. The refrigerator of claim 1, wherein the auto-closing device comprises:
a lever configured to be rotatable about a position that is spaced apart from a rotation center of the door; and
an elastic member connected to the lever.

3. The refrigerator of claim 2, wherein the damping mechanism comprises a damper configured to be in contact with the lever.

4. The refrigerator of claim 3, wherein the damping mechanism further comprises a fixing bracket to couple the damping mechanism to the door at one side of the auto-closing device.

5. The refrigerator of claim 3, wherein the damper comprise:
a fixed member; and
a movable member configured to move relative to the fixed member, the movable member being connected to the lever or in contact with one surface of the lever.

6. The refrigerator of claim 5, wherein a portion of the lever is disposed between the damper and a rotation center of the lever.

7. The refrigerator of claim 5, wherein the movable member comprises a connection portion, and
wherein the lever comprises a slot configured to receive the connection portion therein.

8. The refrigerator of claim 3, wherein the damper is located on the auto-closing device or on the door at a position adjacent to the auto-closing device.

9. The refrigerator of claim 8, wherein the auto-closing device comprises a case configured to accommodate the elastic member therein, and
wherein the damping mechanism includes an outer body configured to accommodate the damper therein, the outer body being located on the case of the auto-closing device or on the door at the position adjacent to the auto-closing device.

10. The refrigerator of claim 8, wherein the damper comprises:
a fixed member; and
a movable member configured to move relative to the fixed member, the movable member being in contact with the lever between the rotation center of the door and a rotation center of the lever.

11. The refrigerator of claim 8, wherein the damper comprises:
a fixed member;
a movable member configured to move relative to the fixed member, and
a spring configured to provide elastic force to the movable member.

12. The refrigerator of claim 5, wherein, when the lever moves in a first direction while the door is being closed, the movable member of the damper moves from a first position to a second position, and
wherein, when the lever moves in a second direction opposite the first direction while the door continues to be moved to the closed position, the movable member of the damper is configured to provide the damping force to the door while moving from the second position to the first position.

13. The refrigerator of claim 1, wherein the auto-closing device comprises:
a lever configured to be rotatable about a position that is spaced apart from a rotation center of the door;
an elastic member connected to the lever; and
a case configured to accommodate the elastic member therein, and
wherein the damping mechanism is located inside the case.

14. The refrigerator of claim 13, wherein the damping mechanism comprises:
a first member connected to the lever; and
a second member configured to be movable with respect to the first member such that, when the first member rotates, the second member moves linearly.

15. The refrigerator of claim 14, wherein a rotation center of the first member is the same as a rotation center of the lever.

16. The refrigerator of claim 14, wherein the damping mechanism further comprises an elastic member configured to elastically support the second member.

17. The refrigerator of claim 14, wherein the first member comprises a first space configured to accommodate oil therein,
wherein the second member comprises a second space configured to accommodate oil therein, and
wherein the damping mechanism includes a buffer space configured to accommodate oil therein, the buffer space being located between the case and the second member.

18. The refrigerator of claim 14, wherein the first member comprises a first uneven portion, and
wherein the second member comprises a second uneven portion that is engaged with the first uneven portion according to a rotational position of the first member.

19. The refrigerator of claim 18, wherein, when the lever moves in a first direction while the door is being closed, the second member of the damping mechanism moves from a first position to a second position due to rotation of the first member, and
wherein, when the lever moves in a second direction opposite the first direction while the door continues to be moved to the closed position, the second member of the damper mechanism is configured to provide the damping force to the door while moving from the second position to the first position.

20. The refrigerator of claim 19, wherein at least a portion of the first uneven portion of the first member is spaced apart from the second member at the second position, and
wherein the at least the portion of the first uneven portion is in contact with and engaged with the second uneven portion of the second member at the first position.
